(19) United States
(12) Patent Application Publication
(10) Pub. No.: US 2026/0004797 A1
(43) Pub. Date: Jan. 1, 2026

(54) SOUND SOURCE SEPARATION SYSTEM

(71) Applicant: ALPS ALPINE CO., LTD., Tokyo (JP)

(72) Inventor: Tomohiko ISE, Fukushima (JP)

(21) Appl. No.: 19/214,611

(22) Filed: May 21, 2025

(30) Foreign Application Priority Data
Jun. 27, 2024 (JP) 2024-103963

(51) Int. Cl. G10L 21/0272; H04R 1/40; H04R 3/00

(52) U.S. Cl. CPC G10L 21/0272; H04R 1/406; H04R 3/005; H04R 2499/13

(57) ABSTRACT

A sound source separation system is configured to perform blind source separation of individual sound source signals by an independent component analysis (ICA) method from a plurality of mixed signals in which two or more sound source signals are mixed. The sound source separation system includes an n number of microphones, where n≥2; a virtual microphone signal generator configured to generate, from output signals of the n number of the microphones, an m number of the virtual microphone signals that are output signals of the m number of virtual unidirectional microphones having directivities in different directions, where m>n; and an ICA processor configured to separate an L number of the sound source signals that are signals of the L number of different sound sources, by the ICA method, from the m number of the virtual microphone signals that are the plurality of the mixed signals, where L>n and L≤m.

### CROSS-REFERENCE TO RELATED APPLICATIONS

The present application is based on and claims priority to Japanese Patent Application No. 2024-103963 filed on Jun. 27, 2024, the entire contents of which are hereby incorporated by reference.

### BACKGROUND

### 1. Field of the Invention

The present disclosure relates to a technique of performing blind source separation of individual sound source signals from mixed signals in which a plurality of sound source signals are mixed.

### 2. Description of the Related Art

As a technique of performing blind source separation of individual sound source signals from mixed signals in which a plurality of sound source signals are mixed, there is a technique of separating individual sound source signals from the mixed signals by an independent component analysis (ICA) method (see, for example, Japanese Laid-Open Patent Application Publication No. 2007-215163). Here, the mixed signals are a mixture of the individual sound source signals obtained through a plurality of microphones disposed in an acoustic space in which a plurality of sound sources are present, and the ICA method is a method of separating the individual sound source signals from the mixed signals based on statistical independence of the individual sound source signals.

Also, as a technique related to the present disclosure, there is a technique using a microarray that combines outputs of a plurality of omnidirectional microphones to generate an output of a virtual unidirectional microphone, and controls the direction of directivity of this virtual unidirectional microphone (see, for example, Japanese Laid-Open Patent Application Publication No. 2016-032260).

### SUMMARY

According to an aspect of the present disclosure, a sound source separation system is configured to perform blind source separation of individual sound source signals, by an independent component analysis (ICA) method, from a plurality of mixed signals in which two or more sound source signals are mixed. The sound source separation system includes: an n number of microphones, where n is greater than 2; a virtual microphone signal generator configured to generate, from output signals of the n number of the microphones, an m number of virtual microphone signals that are output signals of the m number of virtual unidirectional microphones having directivities in different directions, where m is greater than n; and an ICA processor configured to separate an L number of the sound source signals that are signals of the L number of different sound sources, by the ICA method, from the m number of the virtual microphone signals that are the plurality of the mixed signals, where L is greater than n, and L is equal to or less than m.

In the above sound source separation system, a relationship between L and m may be set to satisfy that L is equal to m.

Also, in the above sound source separation system, the directions of the directivities of the m number of the virtual unidirectional microphones may be set at equiangular intervals.

Also, in the above sound source separation system, the directions of the directivities of the L number of the virtual unidirectional microphones out of the m number of the virtual unidirectional microphones may be set to directions toward the L number of the sound sources.

Also, in the above sound source separation system, the virtual microphone signal generator may be configured to change the directions of the directivities of the m number of the virtual microphone signals. In addition, the above sound source separation system may include: a sound source detector configured to detect the directions of the L number of the sound sources; and a directivity controller configured to control the virtual microphone signal generator such that the directions of the directivities of the L number of the virtual unidirectional microphones out of the m number of the virtual unidirectional microphones are the directions toward the L number of the sound sources detected by the sound source detector.

Here, in the above sound source separation system, the n number of the microphones may be disposed in a vehicle to collect sounds in an interior of the vehicle.

The above sound source separation system generates, from the outputs of the n number of the microphones, where n is greater than 2, the m number of the virtual microphone signals that are the output signals of the m number of the virtual unidirectional microphones having the directivities in the different directions, where m is greater than n; and separates the L number of the sound source signals that are the signals of the L number of the different sound sources, by the ICA method, from the m number of the virtual microphone signals that are the plurality of the mixed signals, where L is greater than n, and L is equal to or less than m. Here, the outputs of the m number of the virtual unidirectional microphones are equivalent to outputs of an m number of real unidirectional microphones. Thus, the separation of the number L of the sound source signals by the ICA method corresponds to separating, from the outputs of the m number of the real unidirectional microphones, where L is equal to or less than m, sound sources equal to or less than the number of the unidirectional microphones.

Therefore, it is possible to successfully separate sound source signals of a number of sound sources greater than the number of microphones by the ICA method.

### BRIEF DESCRIPTION OF THE DRAWINGS

FIG. 1 is a block diagram illustrating the configuration of a sound source separation system according to an embodiment of the present disclosure;

FIGS. 2A and 2B are diagrams illustrating directions (sound collection axes) of a unidirectional sound generated in the embodiment of the present disclosure;

FIGS. 3A and 3B are diagrams illustrating an example of the configuration of a beamformer according to the embodiment of the present disclosure;

FIGS. 4A and 4B are diagrams illustrating an applied example of the sound source separation system according to the embodiment of the present disclosure;

FIGS. 5A, 5B, 5C, and 5D are diagrams illustrating another example of the configuration of the sound source separation system according to the embodiment of the present disclosure; and

FIG. 6 is a block diagram illustrating the another example of the configuration of the sound source separation system according to the embodiment of the present disclosure.

### DETAILED DESCRIPTION

The ICA method in the related art is not applicable to separation of sound source signals of a number of sound sources greater than the number of microphones. Thus, there is a need to provide a number of microphones that is equal to or greater than the number of sound sources from which sound source signals are to be separated. This increases the cost for separation of multiple sound sources.

Therefore, the present disclosure provides the ability to successfully separate sound source signals of a number of sound sources greater than the number of microphones by the ICA method.

Hereinafter, embodiments of the present disclosure will be described.

First, a first embodiment will be described.

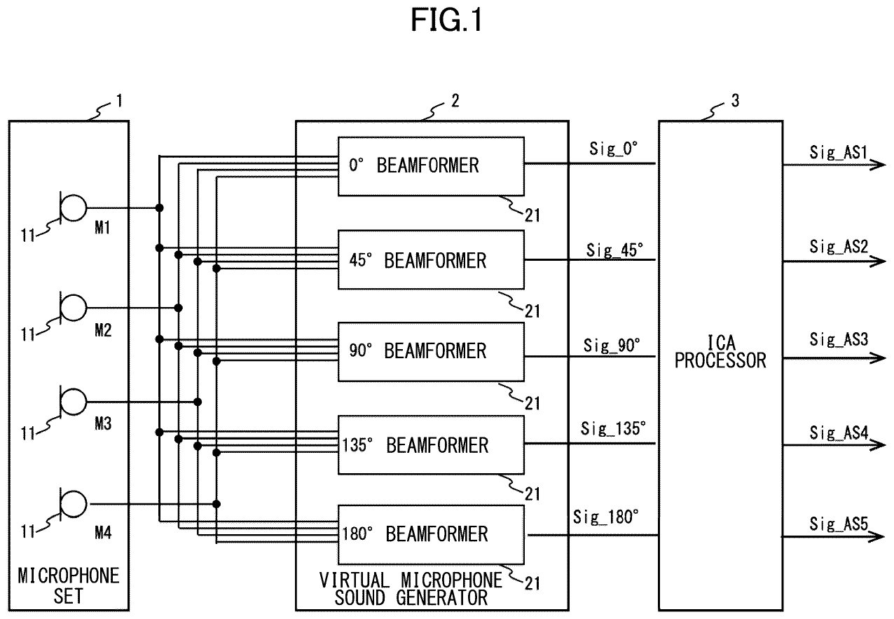

FIG. 1 illustrates the configuration of the sound source separation system according to the present embodiment.

As illustrated, the sound source separation system includes a microphone set 1, a virtual microphone sound generator 2, and an ICA processor 3.

The microphone set 1 includes four omnidirectional microphones 11, i.e., M1, M2, M3, and M4. The four microphones 11 are disposed apart from each other.

The virtual microphone sound generator 2 includes five beamformers 21, i.e., a 0° beamformer, a 45° beamformer, a 90° beamformer, a 135° beamformer, and a 180° beamformer. Outputs of all the four microphones 11 are input to each of the beamformers 21.

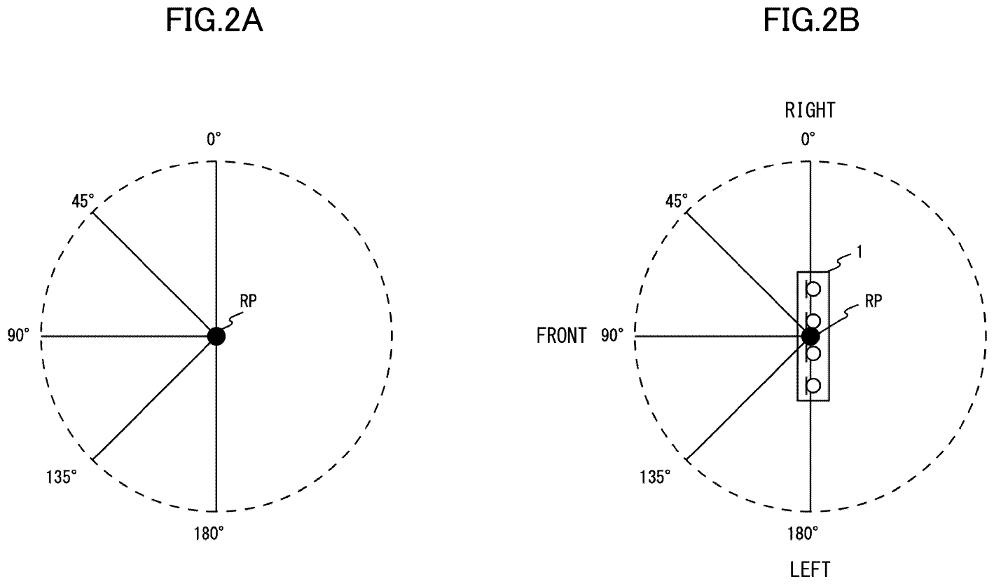

As illustrated in FIG. 2A, with a predetermined direction as viewed from a predetermined reference point RP of the microphone set 1 being a 90° direction, the 0° beamformer 21 generates a virtual microphone signal Sig_0°, which is an output of a virtual unidirectional microphone having a directivity in the 0° direction, from the outputs of the four microphones 11, and outputs the virtual microphone signal Sig_0° to the ICA processor 3; the 45° beamformer 21 generates a virtual microphone signal Sig_45°, which is an output of a virtual unidirectional microphone having a directivity in the 45° direction, from the outputs of the four microphones 11, and outputs the virtual microphone signal Sig_45° to the ICA processor 3; the 90° beamformer 21 generates a virtual microphone signal Sig_90°, which is an output of a virtual unidirectional microphone having a directivity in the 90° direction, from the outputs of the four microphones 11, and outputs the virtual microphone signal Sig_90° to the ICA processor 3; the 135° beamformer 21 generates a virtual microphone signal Sig_135°, which is an output of a virtual unidirectional microphone having a directivity in the 135° direction, from the outputs of the four microphones 11, and outputs the virtual microphone signal Sig_135° to the ICA processor 3; and the 180° beamformer 21 generates a virtual microphone signal Sig_180°, which is an output of a virtual unidirectional microphone having a directivity in the 180° direction, from the outputs of the four microphones 11, and outputs the virtual microphone signal Sig_180° to the ICA processor 3.

When the four microphones 11 are one-dimensionally arranged in the microphone set 1 for use, as illustrated in FIG. 2B, the reference point RP can be set as the center of the microphone set 1, the 90° direction can be set as a front direction that is a direction perpendicular to an arrangement direction of the four microphones 11, the 0° direction can be set as a right direction of the microphone set 1, and the 180° direction can be set as a left direction of the microphone set 1.

Here, the configuration of each of the beamformers 21 will be described taking, as an example, a case in which a delay-and-sum-type microphone array is formed by the microphone set 1 and the beamformers 21.

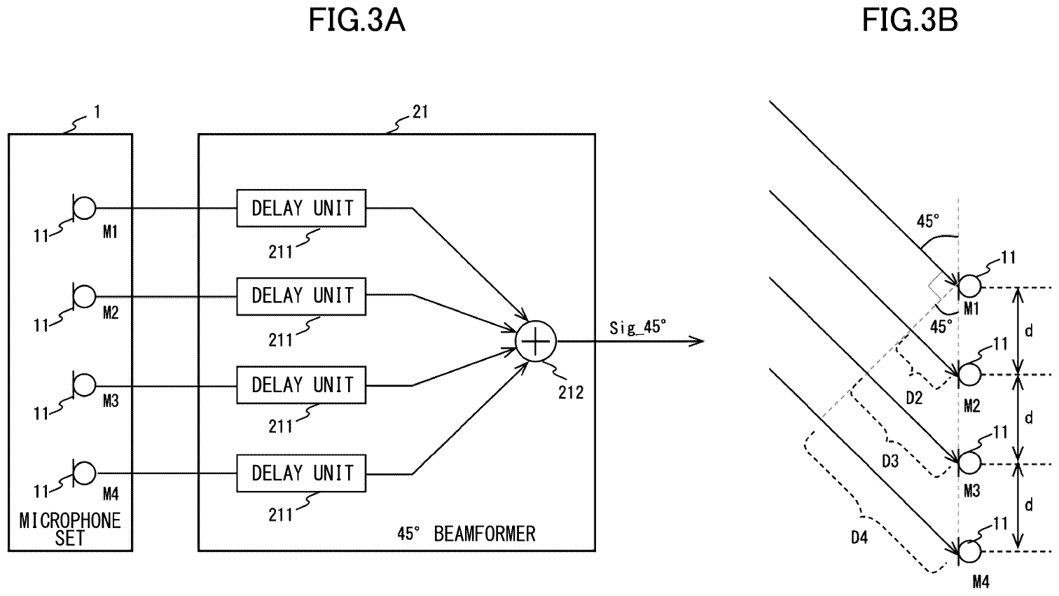

The five beamformers 21 have similar configurations. FIG. 3A illustrates the configuration of the 45° beamformer 21 as a representative.

In this case, as illustrated, the 45° beamformer 21 includes four delay units 211 corresponding, one to one, to the four microphones 11, and an adder 212 configured to add outputs of the delay units 211 and output the sum to the ICA processor 3 as the virtual microphone signal Sig_45°.

As illustrated in FIG. 3B, which uses the microphone set 1 in which the four microphones 11 are uniformly arranged in a one-dimensional direction, delay differences corresponding to the positions of the microphones 11 occur in sounds arriving from the 45° direction at the microphones 11. Where d denotes the interval between the microphones 11 next to each other, these delay differences are that the sound arriving at the microphone M2 is delayed by D2=d×sin45° compared to the sound arriving at the microphone M1, the sound arriving at the microphone M3 is delayed by D3=2d×sin45° compared to the sound arriving at the microphone M1, and the sound arriving at the microphone M4 is delayed by D4=3d×sin45° compared to the sound arriving at the microphone M1.

The four delay units 211 are set in terms of time delays such that the delays in the outputs of the four microphones 11 are uniform and the delays between the virtual microphone signal output by any one of the beamformers 21 and the virtual microphone signals output by the other beamformers 21 are uniform. For example, where Dx denotes a time delay for making uniform the delays between the virtual microphone signal output by any one of the beamformers 21 and the virtual microphone signals output by the other beamformers 21, the time delay of the delay unit 211 corresponding to M1 is set to D4+Dx, the time delay of the delay unit 211 corresponding to M2 is set to (D4−D2)+Dx, the time delay of the delay unit 211 corresponding to M3 is set to (D4−D3)+Dx, and the time delay of the delay unit 211 corresponding to M4 is set to Dx.

As a result, the virtual microphone signal Sig_45° output by the adder 212 is a sound in which the sounds arriving from the 45° direction at the microphones 11 are added in the same phase, and is a signal having a directivity in the 45° direction.

As illustrated in FIG. 1, by using, as five different inputs from the four microphones 11, five virtual microphone signals Sig_0°, Sig_45°, Sig_90°, Sig_135°, and Sig_180° input from the virtual microphone sound generator 2, the ICA processor 3 separates, and outputs, sound source signals Sig_AS1, Sig_AS2, Sig_AS3, Sig_AS4, and Sig_AS5 of the five different sound sources by the ICA method.

As described above, the sound source separation system according to the present embodiment generates, from the outputs of the four microphones 11, the outputs of the five virtual unidirectional microphones having directivities in different directions; and performs sound source separation of five sound sources by the ICA method for the outputs of the five virtual unidirectional microphones. Here, the outputs of the five virtual unidirectional microphones are equivalent to outputs of five real unidirectional microphones. Thus, the process performed by the ICA processor 3 corresponds to performing sound source separation, from the outputs of the five real unidirectional microphones, by the ICA method, of five sound sources that are equal in number to the number of the unidirectional microphones.

Therefore, the ICA processor 3 can successfully separate sound source signals of a number of sound sources greater than the number of the microphones 11 in the microphone set 1.

Next, an applied example of the sound source separation system according to the present embodiment will be described.

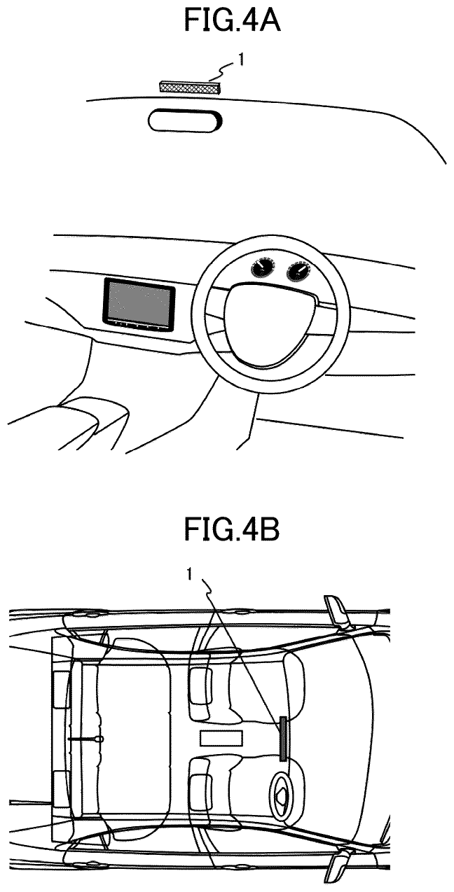

The sound source separation system is applicable, for example, to sound source separation of a plurality of sound sources in the interior of a vehicle. In this case, the microphone set 1 is disposed at a position that can widely collect sounds in the interior of the vehicle. Such a position that can widely collect sounds in the interior of the vehicle can be at the front portion of the ceiling in the interior of the vehicle or on the dashboard, as illustrated in FIGS. 4A and 4B, or can be, for example, at the center of the ceiling in the interior of the vehicle.

The sound sources and the sound source signals in the interior of the vehicle include, for example, in-vehicle speakers and output sounds of the in-vehicle speakers, in-vehicle devices and alarm sounds of the in-vehicle devices, and passengers and their voices upon utterance.

When the sound source separation system is applied to the sound source separation in the interior of the vehicle in this manner, the sound source signals separated by the sound source separation system can be used, for example, as noise source signals for an active noise control to perform control such that the passengers of the vehicle do not hear sounds, as noise, of sound sources unnecessary for the passengers.

The embodiments of the present disclosure have been described above.

In the above, although the directions of the directivities of the virtual microphone signals generated by the beamformers 21 of the virtual microphone sound generator 2 are 0°, 45°, 90°, 135°, and 180°, the directions of the directivities of the virtual microphone signals generated by the beamformers 21 may be any directions as long as the directions are different from each other.

For example, when the directions toward the sound sources from which the sound source signals are to be separated are known, the directions of the directivities of the virtual microphone signals generated by the beamformers 21 may be the known directions toward the sound sources.

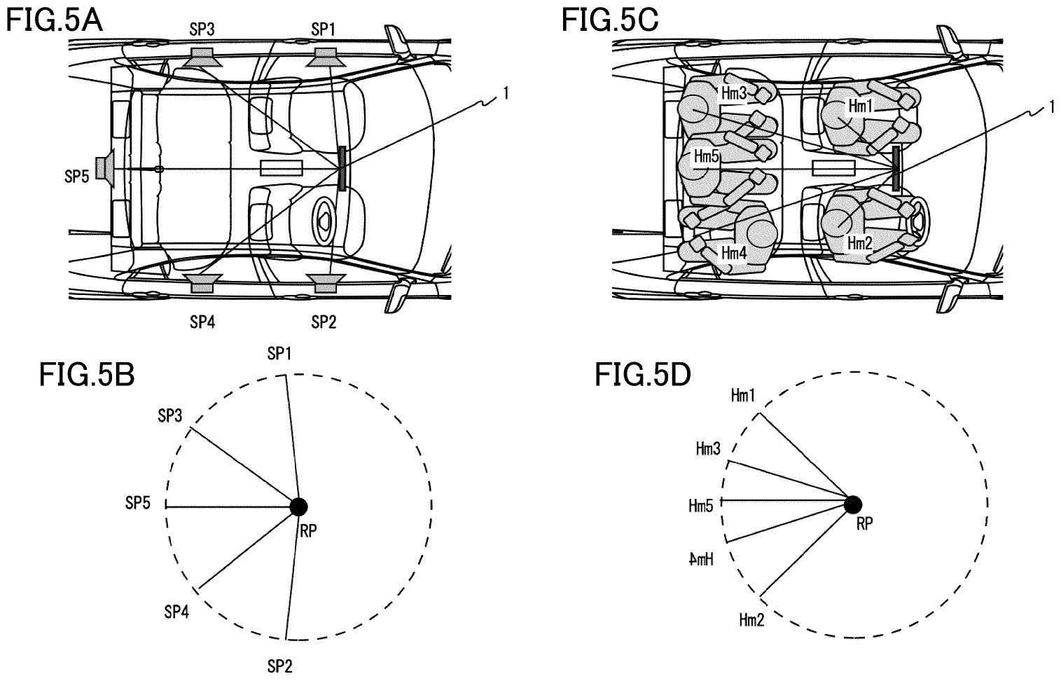

That is, for example, when, as illustrated in FIG. 5A, the microphone set 1 is disposed at the front portion of the ceiling, in-vehicle speakers SP1, SP2, SP3, SP4, and SP5 in FIG. 5A are sound sources, and the speaker output sounds are to be separated as sound source signals, the directions toward the in-vehicle speakers SP1, SP2, SP3, SP4, and SP5 as viewed from the microphone set 1 may be set as the directions of the directivities of the virtual microphone signals generated by the beamformers 21, as illustrated in FIG. 5B.

Similarly, when, as illustrated in FIG. 5C, the microphone set 1 is disposed at the front portion of the ceiling, passengers Hm1, Hm2, Hm3, Hm4, and Hm5 sitting on the seats in FIG. 5C are sound sources, and the passengers' utterance sounds are to be separated as sound source signals, the directions toward the standard head positions of human bodies sitting on the seats as viewed from the microphone set 1 may be set as the directions of the directivities of the virtual microphone signals generated by the beamformers 21, as illustrated in FIG. 5D.

In the above, although the number of the microphones 11 in the microphone set 1 is four, and the number of the virtual microphone signals generated by the virtual microphone sound generator 2 or the sound source signals separated by the ICA processor 3 is five, the number of the microphones 11 in the microphone set 1 may be any number of two or more.

The number of the virtual microphone signals generated by the virtual microphone sound generator 2 or the sound source signals separated by the ICA processor 3 may be any number greater than the number of the microphones 11. In this case, the number of the sound source signals separated by the ICA processor 3 may be less than the number of the virtual microphone signals generated by the virtual microphone sound generator 2.

In this case, the directions of the directivities of the virtual microphone signals generated by the beamformers 21 may be any directions as long as the directions are different from each other.

By setting the directions of the directivities of the virtual microphone signals to the directions toward the sound sources, it is possible to achieve, for example, better sound source separation, and rapid convergence of parameters (separation matrix) used for a process of sound source separation.

In the above embodiments, although the directions of the directivities of the virtual microphone signals generated by the beamformers 21 of the virtual microphone sound generator 2 are fixed, the directions of the directivities of the virtual microphone signals may be variable with the positions of the sound sources.

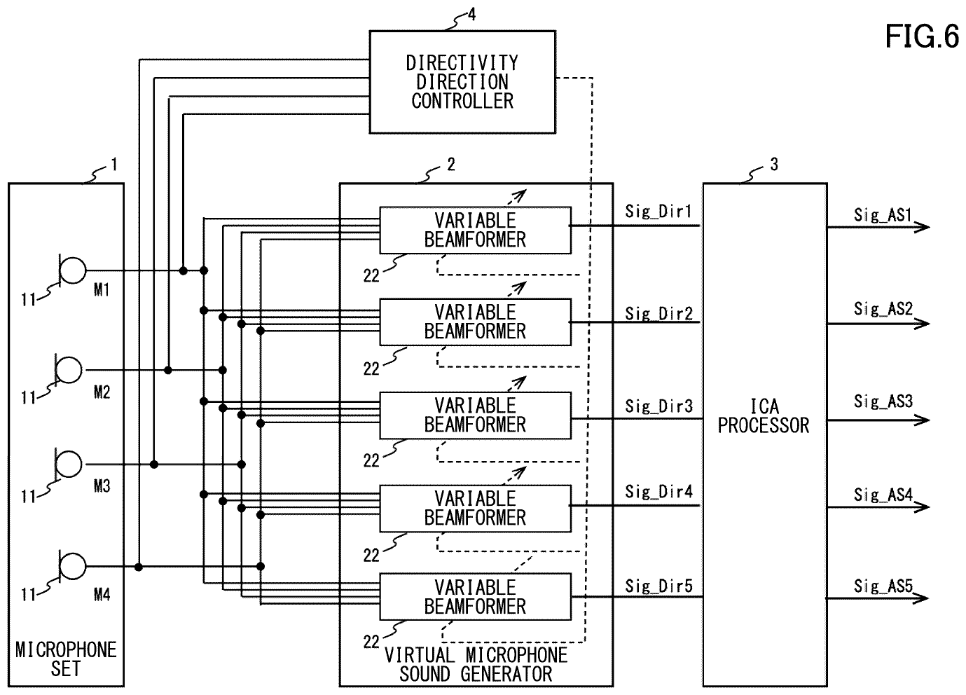

That is, in this case, as illustrated in FIG. 6, the virtual microphone sound generator 2 includes, instead of the five beamformers 21, five variable beamformers 22, which are beamformers that are variable in directivity. In addition, the virtual microphone sound generator 2 further includes a directivity direction controller 4 configured to detect the directions toward the sound sources, and adjust the directions of the directivities of the variable beamformers 22 to the directions toward the sound sources. By using, as five different inputs from the microphones 11, five virtual microphone signals Sig_Dir1, Sig_Dir2, Sig_Dir3, Sig_Dir4, and Sig_Dir5 input from the variable beamformers 22 of the virtual microphone sound generator 2, the ICA processor 3 separates, and outputs, sound source signals Sig_AS1, Sig_AS2, Sig_AS3, Sig_AS4, and Sig_AS5, which are signals of five different sound sources, by the ICA method.

The variable beamformers 22 variable in directivity can be configured, for example, by replacing the delay units 211, in the configuration of the beamformers 21 illustrated in FIG. 3A, with variable delay units that are variable in time delay. In this case, the directivity direction controller 4 can change the directions of the directivities of the variable beamformers 22 by changing the time delay of the variable delay units.

Also, the detection of the directions toward the sound sources in the directivity direction controller 4 can be performed based on the difference between the arrival times, at the microphones 11, of highly correlated components contained in the outputs of the four microphones 11. Alternatively, for example, the detection of the directions toward the sound sources in the directivity direction controller 4 can be performed by generating, from the outputs of the four microphones 11, outputs of the virtual unidirectional microphones 11 for searching for sound source directions, and by changing the directions of the directivities of the virtual microphones 11 for searching for sound source directions so as to scan an acoustic space in which a plurality of sound sources are present, thereby detecting, as the directions toward the sound sources, directions in which the levels of the output sounds of the virtual microphones 11 for searching for sound source directions are high.

Also, when specific objects alone, such as humans or the like, are sound sources, the objects may be detected through, for example, pattern matching using a sensor, such as a camera, a LiDAR sensor, or the like, and the directions of the detected objects relative to the microphone set 1 may be detected as the directions toward the sound sources in the directivity direction controller 4.

In the above, although an example of the configuration of the beamformers 21 forming a delay-and-sum-type microphone array with the microphone set 1 has been described with reference to FIG. 3A, the configuration of the beamformers 21 may be any other configuration, and the beamformers 21 may be delay-subtraction-type beamformers, filter-and-sum-type beamformers, or the like.

As described above, according to the present disclosure, it is possible to successfully separate sound source signals of a number of sound sources greater than the number of microphones by the ICA method.

Although the embodiments of the present invention have been described above in detail, the present invention is not limited to these embodiments, and various modifications or alterations may be possible within the scope of the intent of the present invention recited in the claims.

Note that the virtual microphone signal generator, the ICA processor, the sound source detector, the directivity controller, the delay unit, the adder, or the like described in the present specification is an electronic circuit, such as a central processing unit (CPU), a graphics processing unit (GPU), a field programmable gate array (FPGA), an application specific integrated circuit (ASIC), or the like, and is configured to execute various processes described in the present specification by executing instruction codes stored in a memory or by being designed as a circuit for specific applications.

What is claimed is:

1. A sound source separation system configured to perform blind source separation of individual sound source signals by an independent component analysis (ICA) method from a plurality of mixed signals in which two or more sound source signals are mixed, the sound source separation system comprising:
an n number of microphones, where n is greater than 2;
a virtual microphone signal generating circuit configured to generate, from output signals of the n number of the microphones, an m number of virtual microphone signals that are output signals of the m number of virtual unidirectional microphones having directivities in different directions, where m is greater than n; and
an ICA processing circuit configured to separate an L number of the sound source signals that are signals of the L number of different sound sources, by the ICA method, from the m number of the virtual microphone signals that are the plurality of the mixed signals, where L is greater than n, and L is equal to or less than m.

2. The sound source separation system according to claim 1, wherein
a relationship between L and m satisfies that L is equal to m.

3. The sound source separation system according to claim 1, wherein
the directions of the directivities of the m number of the virtual unidirectional microphones are set at equiangular intervals.

4. The sound source separation system according to claim 1, wherein
the directions of the directivities of the L number of the virtual unidirectional microphones out of the m number of the virtual unidirectional microphones are set to directions toward the L number of the sound sources.

5. The sound source separation system according to claim 1, wherein
the virtual microphone signal generating circuit is configured to change the directions of the directivities of the m number of the virtual microphone signals, and
the sound source separation system includes
a sound source detecting circuit configured to detect the directions of the L number of the sound sources, and
a directivity control circuit configured to control the virtual microphone signal generating circuit such that the directions of the directivities of the L number of the virtual unidirectional microphones out of the m number of the virtual unidirectional microphones are the directions toward the L number of the sound sources detected by the sound source detecting circuit.

6. The sound source separation system according to claim 1, wherein
the n number of the microphones are disposed in a vehicle to collect sounds in an interior of the vehicle.

7. The sound source separation system according to claim 2, wherein
the n number of the microphones are disposed in a vehicle to collect sounds in an interior of the vehicle.

8. The sound source separation system according to claim 3, wherein
the n number of the microphones are disposed in a vehicle to collect sounds in an interior of the vehicle.

9. The sound source separation system according to claim 4, wherein
the n number of the microphones are disposed in a vehicle to collect sounds in an interior of the vehicle.

10. The sound source separation system according to claim 5, wherein
the n number of the microphones are disposed in a vehicle to collect sounds in an interior of the vehicle.
